(19) United States
(12) Patent Application Publication
(10) Pub. No.: US 2023/0112748 A1
(43) Pub. Date: Apr. 13, 2023

(54) AN OIL CONTROL SOLENOID VALVE WITH BUSH ASSEMBLY FOR PRESSURE BALANCE AND A METHOD THEREOF

(71) Applicant: PADMINI VNA MECHATRONICS PVT. LTD., GURGAON (IN)

(72) Inventors: KABIR BHANDARI, GURGAON (IN); AMARDIP KUMAR, GURGAON (IN); KUMAR ABHISHEK, GURGAON (IN); SUDHIR PATTNAIK, GURGAON (IN)

(21) Appl. No.: 17/904,141

(22) PCT Filed: Feb. 12, 2021
(86) PCT No.: PCT/IB2021/051202

§ 371 Date: Aug. 12, 2022

(30) Foreign Application Priority Data
Feb. 12, 2020 (IN) 202011006134

(51) Int. Cl. F16K 31/06; F01M 1/02

(52) U.S. Cl. CPC F16K 31/0655; F01M 1/02; F01M 2001/0223

(57) ABSTRACT

The present invention relates to an oil control solenoid valve with improved pressure balance for high pressure applications and a method of assembling thereof. More particularly, the present invention provides an oil control solenoid valve (101) with a pressure balance assembly comprising of a fixed sleeve (2) with at least one inlet and one outlet, a movable plunger (1) having two ends and at least one bush (3) and the method of assembling thereof thus providing the pressure balance at both the ends of the plunger (1).

### FIELD OF THE INVENTION

The present invention relates to an oil control solenoid valve with improved pressure balance for high pressure applications and a method of assembling thereof. More particularly, the present invention provides an oil control solenoid valve with a pressure balance assembly comprising of a fixed sleeve with at least one inlet and one outlet, a movable plunger having two ends and at least one bush and the method of assembling thereof thus providing the pressure balance at both the ends of the plunger.

### BACKGROUND OF THE INVENTION

A solenoid device is an electromechanical control unit which shuts or allows the fluid flow, when electrically energized or de-energized. It consists of several parts such as but not limited to solenoid coil, bobbin, movable core, core tube, seal body, plunger, sleeve etc. The magnetic coil of the solenoid is arranged radially relative to the axis of the magnet because the flux of the permanent magnet also extends radially relative to the operating axis of the valve plug and through the armature. There are several areas where solenoid valve is useful such as in pneumatic and hydraulic systems to control cylinders or larger industrial valves, automatic irrigation sprinkler systems also use solenoid valves with an automatic controller.

An oil control valve is a vital part of every engine and is responsible for controlling oil flow in the camshaft and in addition it also helps in sustaining the functioning of the internal moving parts of the engine. Oil control valves have an important role in efficient fuel consumption, reducing gas emissions generated by vehicle. These valves perform various tasks including releasing, shutting off, mixing or distributing fluids. These valves usually offer fast and safe switching, high reliability, long service life and low control power. The oil control solenoid valves are readily useful in oil cooling of turbo charger bearing mechanism.

There is a lot of research going on in area of designing an oil control solenoid valve which is able to deliver fast and safe switching along with low power consumption. The fast and safe switching along with low power consumption is only possible if there is a balance of pressure in the valve. In scenario of uneven pressure situations there is a chance of high power consumption, reduced speed of switching and power failure issues.

EP1647750A1 discloses a solenoid valve composed primarily of a solenoid section and a spool control valve joined with the solenoid section. The solenoid valve is able to secure the damping effect of the working oil on the spool valve and a plunger and to suppress the self-oscillation even while being operated in the atmosphere for a long time. The invention does not offer efficient pressure balance.

The commercially available oil control solenoid valves usually have such as design that they comprise of a plunger which has an oil contact area at the inlet which is less as compared to the oil contact area of the plunger nearby the coil. This offers a compromised pressure balance and slow switching response. Although it is easier to balance pressure in three-way oil control solenoid valves, doing so in a two-way valve is difficult.

Therefore, there is a need of a technology that offers pressure balance as well as even fast switching response. There is a need of an oil control solenoid valve that offers pressure balance and fast On and Off cycle along with a radial seal with bush and axial seal with sleeve.

### OBJECT OF THE INVENTION

The main object of the present invention is to provide an oil control solenoid valve with an improved pressure balance comprising of a fixed sleeve containing at least one inlet and one outlet, a plunger and at least one bush thus providing the pressure balance at both the ends of the plunger.

Another object of the present invention is to provide a method of assembling the oil control solenoid valve with bush to achieve pressure balance.

Yet another object of the present invention is to provide a robust control solenoid valve with improved pressure balance and improved on and off cycle of oil solenoid valve for better high-pressure applications.

Yet another object of the present invention is to provide an oil control solenoid valve with an oil contact area equal at both ends of the plunger for maintaining the pressure balance utilizing a bush.

Still another object of the present invention is to provide a two-way oil control solenoid valve with improved pressure balance and improved operation at high pressure applications.

### SUMMARY OF THE INVENTION

The present invention provides an oil control solenoid valve with an improved pressure balance comprising of a fixed sleeve with at least one inlet and one outlet, a movable plunger having two ends and at least one bush thus providing the pressure balance at both the ends of the movable plunger and a method of assembling thereof. The movable plunger seals the bush radially and seals the sleeve axially.

In a preferred embodiment, the present invention provides an oil control solenoid valve with improved pressure balance comprising of a fixed sleeve with at least one inlet and one outlet, a movable plunger having two ends and at least one bush thus providing the pressure balance at both the ends of the movable plunger. The fixed sleeve is a fixed part and contains an inlet port as well as an outlet port in it. The plunger is a movable part and makes sealing with bush radially and with fixed sleeve axially when the valve is actuated. The contact area at the top and the bottom end of the movable plunger is made equal with help of bush to achieve pressure balance at both end and On and Off the valve effectively. Therefore, the oil control solenoid valve has an improved pressure balance and an improved On and Off cycle of said valve up to higher pressure ranges. The movable plunger is modified such that the diameter of the movable plunger at the top diameter is reduced and the bush is inserted between the fixed sleeve and movable plunger to make the contact are equal at both top and bottom end of the movable plunger.

In another preferred embodiment, the present invention provides a method of assembling the oil control solenoid valve with bush. Said method comprising the steps of: sliding a guide pin in a cut out provided at the top of movable plunger; sliding bush from top of the movable plunger such that it engages with the movable plunger; and sliding plunger with bush in sleeve from the top such that a top edge of bush fits with the sleeve.

### BRIEF DESCRIPTION OF THE DRAWINGS

A complete understanding of the system and method of the present invention may be obtained by reference to the following drawings:

FIG. 1 illustrates a sectional view of conventional oil control solenoid valve in accordance with state of the art.

FIG. 2 illustrates a sectional view of oil control solenoid valve in accordance with the present invention.

FIG. 3 illustrates an enlarged view of conventional oil control solenoid valve in accordance with state of the art.

FIG. 4 illustrates an enlarged view of oil control solenoid valve in accordance with the present invention.

FIG. 5 illustrates a method of assembling in the oil control solenoid valve in accordance with the present invention.

### DETAILED DESCRIPTION OF THE INVENTION

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

In a preferred embodiment, the present invention provides an oil control solenoid valve with improved pressure balance comprising of a fixed sleeve with at least one inlet and one outlet, a movable plunger having two ends and at least one bush thus providing the pressure balance at both the ends of the movable plunger. The fixed sleeve is a fixed part and contains an inlet port as well as an outlet port in it. The plunger is a movable part and makes sealing with bush radially and with fixed sleeve axially when the valve is actuated. The contact area at the top and the bottom end of the movable plunger is made equal with help of bush to achieve pressure balance at both end and On and Off the valve effectively. Therefore, the oil control solenoid valve has an improved pressure balance and an improved On and Off cycle of said valve. The movable plunger is modified such that the diameter of the movable plunger at the top diameter is reduced and the bush is inserted between the fixed sleeve and movable plunger to ensure that the contact area is equal at both top and bottom end of the movable plunger.

Here, the movable plunger is preferably made of brass and is modified for pressure balance. The fixed sleeve containing the inlet port as well as outlet port is preferably made of aluminum or steel. The bush is preferably made of brass or steel and is inserted between the sleeve and movable plunger. However, the movable plunger, sleeve and bush may be made using a material including but not limited to a thermoplastic, thermoset, metal or ceramic material.

In another preferred embodiment, the present invention provides a method of assembling the oil control solenoid valve with bush. Said method comprising the steps of: sliding a guide pin in a cut out provided at the top of plunger; sliding bush from top of the plunger such that it engages with the movable plunger; and sliding plunger with bush in fixed sleeve from the top such that a top edge of bush fits with the fixed sleeve. The diameter of top end of plunger is less than diameter of bottom end by approximately 0.3 mm. The inner diameter of bush is such that it qualifies the outer diameter of movable plunger when the bush slides down. The outer diameter of bush qualifies the inner diameter of the fixed sleeve when the movable plunger with bush slides down in the fixed sleeve.

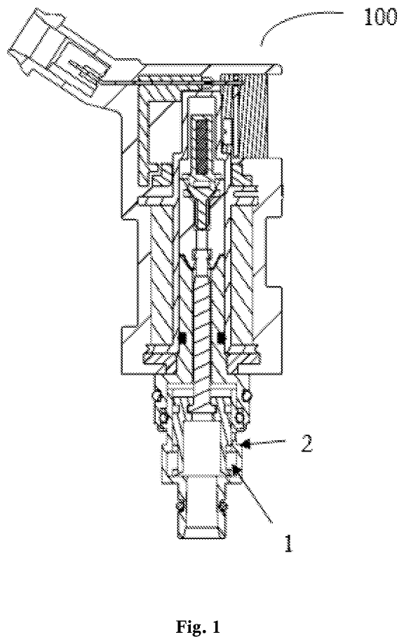

FIG. 1 shows sectional view of conventional oil control solenoid valve (100) comprising of a fixed sleeve (2) having axial hollow area with at least one inlet and one outlet. A plunger (1) with a top end (1a) and a bottom end (1b) is inserted in the given axial hollow area and is movable in nature. The diameter of the top end (1a) of the plunger (1) near to coil is greater than the diameter of the bottom end (1b) of the plunger (1) near to inlet of sleeve. The oil contact area of the plunger (1) at the top end near to coil is greater than the oil contact area of the plunger (1) at the bottom end near to inlet of sleeve. In the conventional design, the contact area at bottom end of the plunger is approximately 0.4 mm less than the contact area on the top end of the plunger.

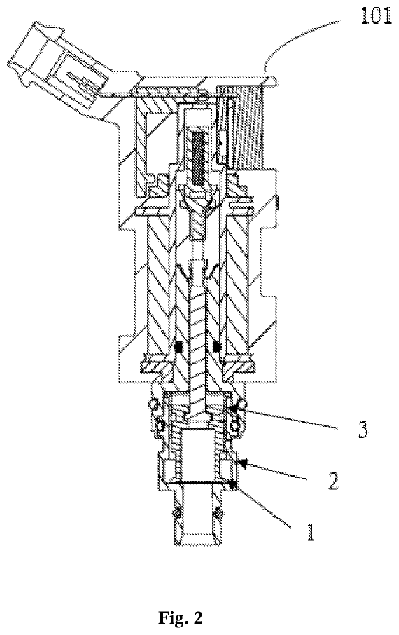

FIG. 2 shows sectional view of oil solenoid valve (101) with improved pressure balance comprising a fixed sleeve (2) with at least one inlet and one outlet, a movable plunger (1) with a top end (1a) and a bottom end (1b) and a bush (3) inserted between the fixed sleeve (2) and the movable plunger (1). The diameter of the plunger (1) at the top end near to coil is reduced such that it is equal to the diameter of the plunger at the bottom end near to inlet. The bush (3) is inserted between the fixed sleeve (2) and moveable plunger (1) helps in balancing the pressure in said valve (101) and makes the oil contact area equal at both the ends of the plunger (1). The top end (1a) and the bottom end (1b) of the plunger (1) are equal. The valve (101) is preferably two way normally open valve. The pressure balance improves the On and Off cycle of the valve (101). Upon actuation, the movable plunger (1) seals the bush (3) radially and the fixed sleeve (2) axially as it moves up and down and the downward movement of the moveable plunger (1) blocks the path of oil from the inlet and outlet port of the fixed sleeve.

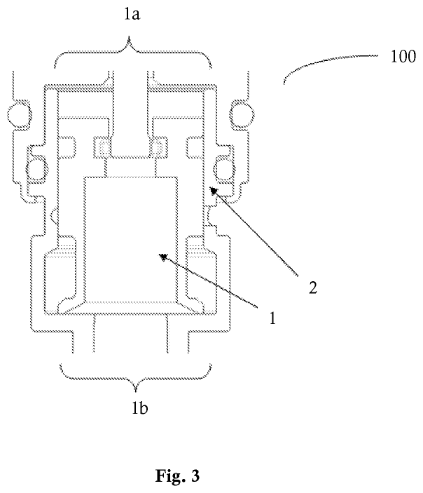

FIG. 3 shows an enlarged view of conventional oil solenoid valve (100) comprising of a fixed sleeve (2) and a movable plunger (2). The diameter of the top end (1a) of the plunger (1) near to coil is greater than the diameter of the bottom end (1b) of the plunger (1) near to inlet. In such arrangement there is a poor pressure balance.

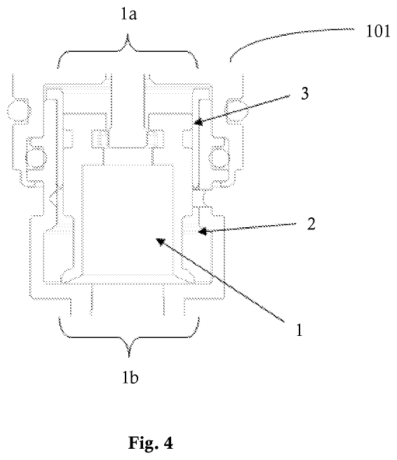

FIG. 4 shows an enlarged view of oil solenoid valve (101) with improved pressure balance comprising a fixed sleeve (2) having at least one inlet and one outlet, a movable plunger (1) with a top end (1a) and a bottom end (1b) and a bush (3). The bush is affixed between the movable plunger (1) and the fixed sleeve (2). The diameter of the top end (1a) of the plunger (1) is equal to the diameter of the bottom end (1b) of the plunger (1).

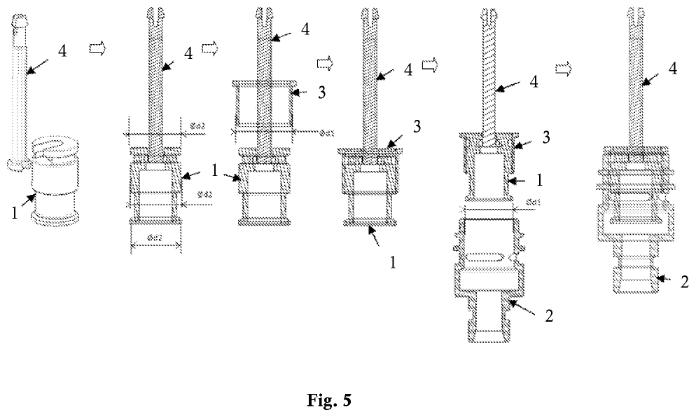

FIG. 5 shows a flow diagram of the method of assembling in the oil control solenoid valve in accordance with the present invention. Said method of assembling comprises the steps: (a) sliding a guide pin (4) in the cut out portion on the top end (1a) of the plunger (1) such that it gets engaged to the plunger (1); (b) sliding bush (3) on plunger (1) such that the inner diameter of bush qualifies the outer diameter of plunger (1); and (c) sliding bush (3) with plunger (1) obtained at step (b) inside fixed sleeve (2) such that the top end (1a) of plunger (1) fits over the fixed sleeve (2).

Therefore, the present invention provides an oil solenoid valve with improved pressure balance and its method of assembling for better operation at high pressure. The pressure balance assembly improves the On and Off cycle of said valve, seals the bush radially and seals the fixed sleeve axially and makes the oil contact area equal at both ends of the plunger. The valve with pressure balance operates said valve perfectly irrespective of oil pressure.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. An oil control solenoid valve (101) with improved pressure balance comprising:
a fixed sleeve (2) with at least one inlet and one outlet;
a moveable plunger (1) with a top end (1a) and bottom end (1b); and
at least one bush (3);
wherein,
said moveable plunger (1) makes a sealing with said bush (3) radially and a sealing with said fixed sleeve (2) axially upon actuation of said oil control solenoid valve (101);
said moveable plunger (1) comprises of at least two contact areas at the top end (1a) and bottom end (1b) that are made equal and diameter of said top end (1a) of said moveable plunger (1) is reduced with respect to diameter of said bottom end (1b) of said moveable plunger (1); and
said bush (3) is inserted between said fixed sleeve (2) and said moveable plunger (1) to make said contact areas equal at both said top (1a) and bottom end (1b) of said moveable plunger (1) that improves pressure balancing and enables a fast On and Off response in said oil control solenoid valve (101).

2. The oil control solenoid valve (101) with improved pressure balance as claimed in claim 1, wherein said movable plunger (1) is made of material including but not limited to brass, alloy steels, carbon steel and alike.

3. The oil control solenoid valve (101) with improved pressure balance as claimed in claim 1, wherein said fixed sleeve (2) is made of material including but not limited to aluminum, steel, brass.

4. The oil control solenoid valve (101) with improved pressure balance as claimed in claim 1, wherein said bush (3) is made of material including but not limited to brass, alloy steels, carbon steel.

5. The oil control solenoid valve (101) with improved pressure balance as claimed in claim 1, wherein said movable plunger (1) seals said sleeve (2) radially and axially upon actuation and moves up and down and downward movement of said moving plunger (1) blocks path of oil from said inlet and outlet port of said fixed sleeve (2).

6. The oil control solenoid valve (101) with improved pressure balance as claimed in claim 1, wherein said oil control solenoid valve (101) includes but not limited to two way normally open valve, three way normally open valve.

7. A method of assembling an oil control solenoid valve (101) comprises the steps of:
(a) sliding a guide pin (4) in a cut out portion on a top end (1a) of a moveable plunger (1) of said oil control solenoid valve (101) such that said guide pin (4) gets engaged to said moveable plunger (1);
(b) sliding a bush (3) on said moveable plunger (1) such that inner diameter of said bush (3) qualifies outer diameter of said moveable plunger (1); and
(c) sliding said bush (3) with said moveable plunger (1) obtained at step (b) inside a fixed sleeve (2) such that said top end (1a) of moveable plunger (1) fits over said fixed sleeve (2).

8. The method as claimed in claim 7, wherein said moveable plunger (1) makes a sealing with said bush (3) radially and a sealing with said fixed sleeve (2) axially upon actuation of said oil control solenoid valve (101).

9. The method as claimed in claim 7, wherein said moveable plunger (1) comprises two contact areas at the top end (1a) and bottom end (1b) that are made equal and diameter of said top end (1a) of said moveable plunger (1) is reduced with respect to diameter of said bottom end (1b) of said moveable plunger (1).
